(19) United States
(12) Patent Application Publication
(10) Pub. No.: US 2016/0095669 A1
(43) Pub. Date: Apr. 7, 2016

(54) ADJUSTABLE ORTHODONTIC BRACKET AND METHOD

(71) Applicant: Mohammad Izadi, Potomac, MD (US)

(72) Inventor: Mohammad Izadi, Potomac, MD (US)

(21) Appl. No.: 14/505,531

(22) Filed: Oct. 3, 2014

(51) Int. Cl. A61C 7/14; A61C 7/20; A61C 1/00; A61C 7/16

(52) U.S. Cl. CPC A61C 7/146; A61C 7/16; A61C 7/20; A61C 1/0046

(57) ABSTRACT

A metal base member and a thin layer of an orthodontic adhesive is used to rigidly secure said base member directly to a tooth; a layer of lead-free heat softenable material for joining two metal surfaces rigidly together and an orthodontic bracket having a face to fit within a surface area of the base member and an engagement receiver for an archwire by which forces are developed in a patient's mouth. In addition, the base member overlaps the base of the bracket by up to about 1.0 mm surrounding the base so that the bracket can be adjusted by an amount of up to about 1.0 mm in all directions around the base member without overlapping the periphery of the base member.

### FIELD OF THE INVENTION

This invention relates to an adjustable orthodontic bracket and a method for adjusting an orthodontic bracket without breaking a bond between a patient's tooth and the bracket.

### BACKGROUND FOR THE INVENTION

The practice of orthodontics requires a considerable amount of chair time with patients so that perfect or near perfect alignment of the patient's teeth can be achieved. When orthodontic brackets (braces) are bonded to the patient's teeth at an initial treatment, it is very difficult if not impossible to precisely position each bracket. The problem is exacerbated by a number of issues. For example, excess crowding of the teeth, angulations of the teeth, lack of access and at times human error or inability to precisely position a bracket on a specific tooth.

A further problem confronting the orthodontist is that the realignment of the teeth following the initial treatment, it becomes apparent that some of the brackets that have been bonded to a patient's teeth need to be repositioned.

This requires removal of the originally bonded bracket from the tooth enamel that causes pain and discomfort, frequently damages the bracket, requires a new bracket, requires removal of the existing bonding material on the patient's teeth, repairing the tooth surface and rebonding a new bracket in the ideal position. This procedure is costly, time consuming and may not necessarily be the last time the orthodontist is replacing that bracket.

After many years, it is still common practice to adhesively bond an orthodontic bracket directly onto a tooth. Nevertheless, there have been attempts to provide adjustable orthodontic brackets. For example, a U.S. Pat. No. 4,243,387 of Prins discloses an Adjustable Orthodontic Bracket that can be fixed to a band to surround a tooth. The bracket has a base to be carried by the tooth, and a movable member to which wires are attached, and a retainer to fix the movable member to the base. In the preferred embodiment, the base and the movable member have spherical surfaces so that motion of the movable member can dispose the bracket at any desired angle in any plane for the desired torque, and in all embodiments the movable member is rotatable about the retainer through 360 degrees and can be set at any desired angle.

A U.S. Pat. No. 4,487,581 of Adler discloses an Orthodontic Bracket. As disclosed therein, an improved orthodontic bracket is formed of a wire gripping block secured within a spring metal base having wings or string tabs which set within tab receiving slots on opposite ends of the block. A slot within the face of the block is configured for gripping an orthodontic banding or arch wire extending from tooth to tooth, the face being large enough to accommodate any desired orientation of the slot to convert tension forces in the wire to a desired amount of torque for inducing a predetermined rotation of the tooth. A central plate portion of the base includes a slot elongated for the guidance of an orthodontic pin between the block and the base while transverse wing portions of the aperture serve as keyways for cooperation with alignment pins extending from a back face of the block. A channel for receipt of the orthodontic pin is also located on the back face of the block. Further, a bifurcated shim having legs contacting cam surfaces of the block for insertion between the block and the base to facilitate removal of the block for interchanging with other blocks, the legs passing outside the alignment pins and one of the tabs, the one tab having peripheral slots for engagement with the legs.

A more recent Kishi U.S. Pat. No. 8,371,846 discloses a Self-Adjustable Self-Ligating Orthodontic Bracket. As disclosed, a self-adjustable, self-ligating orthodontic bracket includes a base with a tooth face bonded to a surface of a tooth. A linking body includes a body connection. The linking body is in physical communication with an archwire transmitting a force to the linking body. A connector applies a tension between the linking body and the base motivating the linking body and the base toward a normal position.

Notwithstanding the above, it is presently believed that there is a need and a potential commercial market for an adjustable orthodontic bracket and method in accordance with the present invention. There should be a commercial market for such devices because they use a base member adhesively bonded to a tooth instead of adhesively bonding the orthodontic bracket on the tooth as commonly done today. The base member has dimensions and configuration that is slightly larger than the bracket. Therefore, the bracket is heat softenable material onto the base member and the base member is adhesively bonded to the tooth. A laser with pinpoint accuracy softens the heat softenable material in order to adjust the bracket.

In addition, the adjustable orthodontic bracket and method are considerably more cost effective, safe, saves hours of an orthodontist's time, relieves a patient from pain and discomfort, and reduces the costs for such treatments.

### SUMMARY OF THE INVENTION

Briefly, an adjustable orthodontic bracket in accordance with the present invention includes a metal base member adapted to be rigidly secured directly to a tooth by a very thin layer of an orthodontic adhesive. Further, a relatively thin layer of lead free heat softenable material for joining two metal surfaces rigidly together is provided together with an orthodontic bracket having a base to fit within a surface area of the base member and an engagement receiver for an archwire by which forces are developed in a patient's mouth. In the device in accordance with the invention, the base member overlaps the base of the bracket surrounding the base so that the bracket can be adjusted in all directions around the base member without overlapping the periphery of the base member.

A further embodiment of the invention contemplates a method for adjusting an orthodontic bracket without breaking a bond between a patient's tooth and a base of an orthodontic bracket. The method comprises the following steps.

Providing a thin layer of an orthodontic adhesive and a metal base member adapted to be rigidly secured directly to a tooth by a thin layer of orthodontic adhesive. In addition, a layer of heat softenable material wherein the surface of the heat softenable material reaches a liquidous stage under heat for bonding two metal surfaces rigidly together. In a preferred embodiment of the invention it is important that an adjustment may be made by sliding or translation of the orthodontic bracket on the base member i.e. with respect to the tooth.

In addition, an orthodontic bracket having a base and wherein the base of the bracket does not overlap the base member. In other words, the base member overlaps the base of the bracket by between 0.5 mm and up to about 1.0 mm on each side thereof so that the bracket can be adjusted by an amount of up to about 1.0 mm in each planar direction without overlapping the base member. The bracket can also be adjusted rotationally about the base member without exceeding the periphery of the base member.

In addition to the above, a diode laser is provided to generate heat of about 138° C. A cordless micro laser identified as StylaOrtho (diode laser) from Zap Dental of Pasedena, Calif. is an example of an appropriate laser.

The invention also contemplates a method of fastening a base member directly to a patient's tooth and bonding the bottom surface of the base member to the tooth. Further, a thin layer of heat softenable material that reaches a liquidous state and heating the heat softenable material to form a liquidous plane between the base of the bracket and the base member. Further, after heating the heat softenable material to a liquidous state the position of the bracket with respect to adjacent teeth and for positioning an archwire is adjusted using the tip of the laser to move the bracket.

Finally, the heat is removed by a pinpoint heat from a diode laser, removed and the softenable material is hardened to properly position the bracket.

The invention will now be described in connection with the accompanying drawings wherein like numbers are used to indicate like elements.

### DESCRIPTION OF THE DRAWINGS

FIG. 1 is a schematic illustration of a prior art bracket assembly attached directly and securely to a patient's tooth and an archwire applying forces to an individual's teeth;

FIG. 2 is a perspective view of a prior art orthodontic bracket bonded directly to the surface of an individual's tooth;

FIG. 3 is a perspective view of an orthodontic bracket attached to a base member which is attached to a tooth in accordance with the present invention;

FIG. 4 is a cross-sectional view of an adjustable orthodontic bracket in accordance with the invention;

FIG. 5 is a partially exploded view of a base member and solder layer as used in a preferred embodiment of the invention;

FIG. 6 is a schematic illustration of the step of applying an orthodontic adhesive being applied to the surface of a tooth and an orthodontic bracket assembly;

FIG. 7 is a schematic illustration of a base member and bracket assembly including a base member in accordance with the invention;

FIG. 8 is a schematic illustration of a base member attached to a tooth and a diode laser for softening the solder prior to repositioning of a bracket;

FIG. 9 is a schematic illustration showing the use of a tip of a laser to reposition an orthodontic bracket on a base member;

FIG. 10 is a schematic illustration of an orthodontic bracket on a base member attached to a tooth before adjustment;

FIG. 11 is a schematic illustration of a tooth and base member shown in FIG. 10 but after readjustment of the bracket on the base member;

FIG. 12 is a perspective view of a base member and a thin layer of solder thereon;

FIG. 13 is a schematic illustration of a base member positioned on a tooth and bracket before adjustment; and

FIG. 14 is a schematic illustration of the base member and bracket after linear adjustment to the left.

### DESCRIPTION OF THE PREFERRED EMBODIMENTS OF THE INVENTION

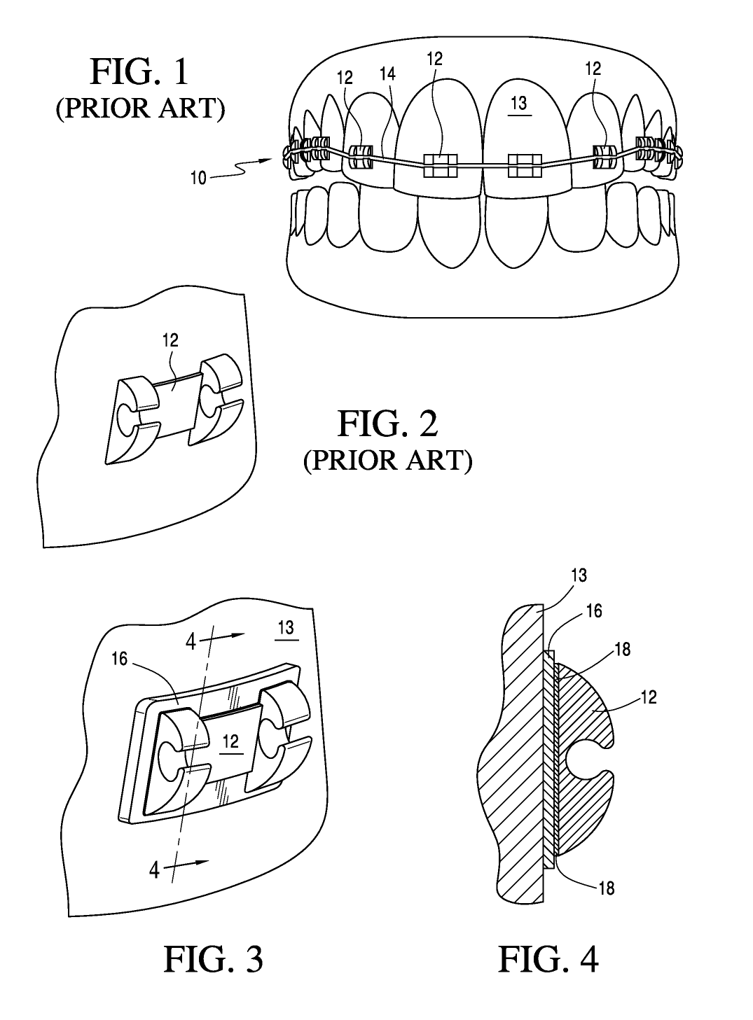

As illustrated, in FIG. 1 a set of orthodontic braces 10 includes a plurality of orthodontic brackets 12 and an archwire 14 for applying forces to reposition the upper teeth in a patient's mouth. As shown in FIG. 1, the orthodontic brackets 12 are directly bonded to the surfaces of a patient's upper teeth. The latter feature is more clearly shown in FIG. 2 wherein a single bracket 12 is securely bonded to a single tooth by an orthodontic adhesive. A bonding material commonly used in orthodontics to adhere a bracket to a tooth surface are composite resins such as Transbond XT (Ref 712-036 manufactured by 3M Unitek), or other similar products manufactured by Ormco, Densply or Reliance, or thermoplastic material.

For contrast, FIG. 3 illustrates a base member 16 preferably of metal that is bonded directly to a tooth by a thin layer of an orthodontic adhesive and is positioned between a relatively flat base of the orthodontic bracket 12 and the tooth 13. It should be recognized that the tooth engaging side of the base member 16 may have a slight curvature to more closely conform to the shape of a tooth, and also may include a ridged surface to enhance its bonding functionality, similar to that of the ridged or cross-hashed surface of the bracket itself.

A key feature of the present invention resides in a heat softenable layer that has a liquidous phase on its surface that allows the orthodontic bracket 12 to be moved linearly or rotationally. For example, a lead-free solder is preferred while a special thermoplastic material developed for this purpose is contemplated and considered promising. As illustrated in FIG. 4, there is a slight overlap of the base of the bracket 12 by the base member 16 to allow for free movement within the confines of the base member. The softenable layer 18 and bracket 12 should not overlap the base member 16 to avoid forming a cavity that would trap food or drink.

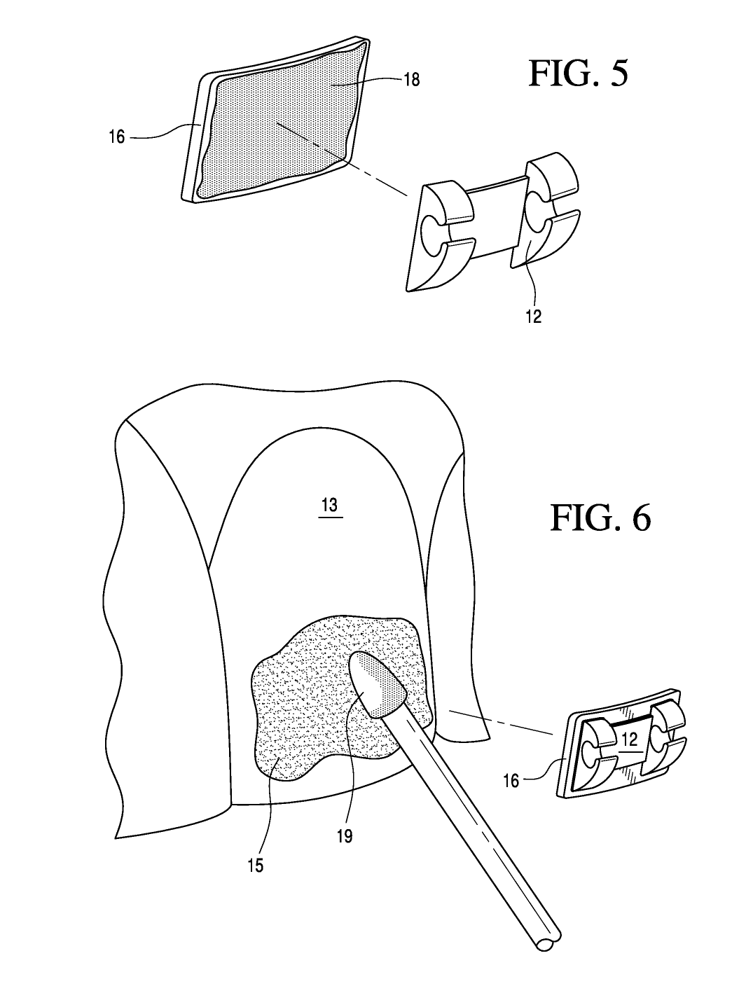

As illustrated in FIG. 5, a layer of heat softenable material such as a lead-free solder that melts at about 138° C. or as low as about 120° C. is disposed between a relatively flat base of the bracket 12 and the base member 16. These assemblies are most likely manufactured in a manufacturer's plant and provided to an orthodontist for use in their practice.

For contrast FIG. 6 illustrates an adhesive applicator 19 for applying a conventional orthodontic adhesive 15 on a surface of a tooth for bonding a base member 16 to the tooth 13. As shown the bracket 12 has already been attached to the base member 16. The best known material to bond the bracket base to a sub-base is lead-free solder, however a specially compounded thermoplastic material is promising.

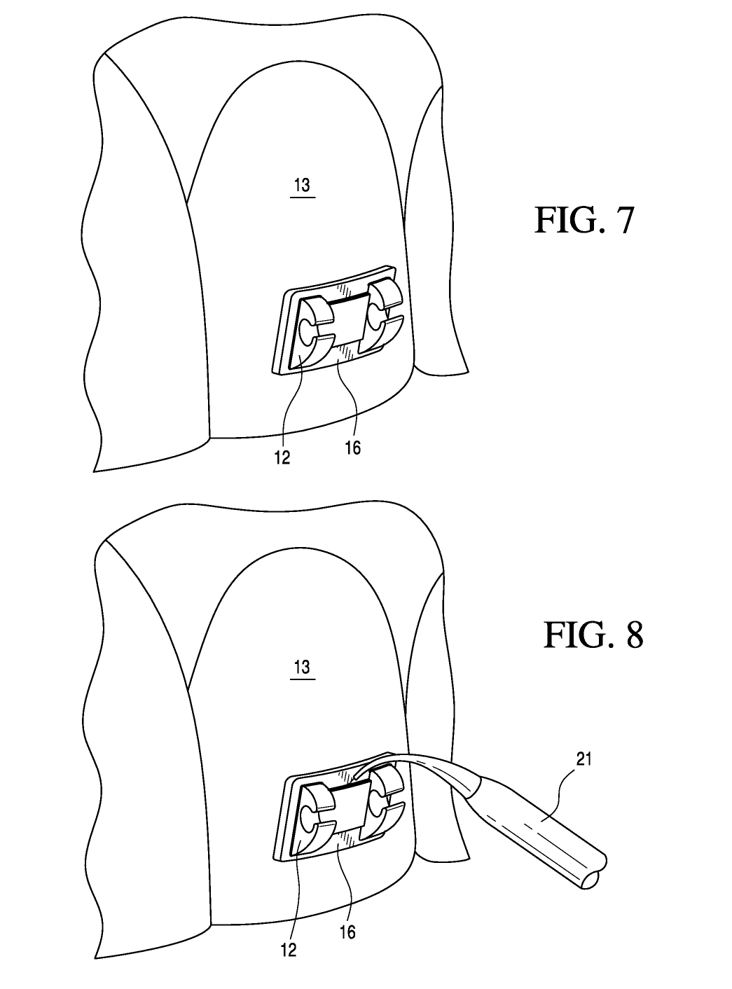

An orthodontic bracket 12 and base member 16 are bonded to a tooth 13 as shown in FIGS. 7 and 8. FIG. 7 illustrates an initial position of a bracket. FIG. 8 illustrates a pinpoint diode laser for heating the heat softenable layer 18 between the bracket 12 and base member 16 with a diode laser for creating a liquidous phase between the base of the bracket and the base member at about 138° C.

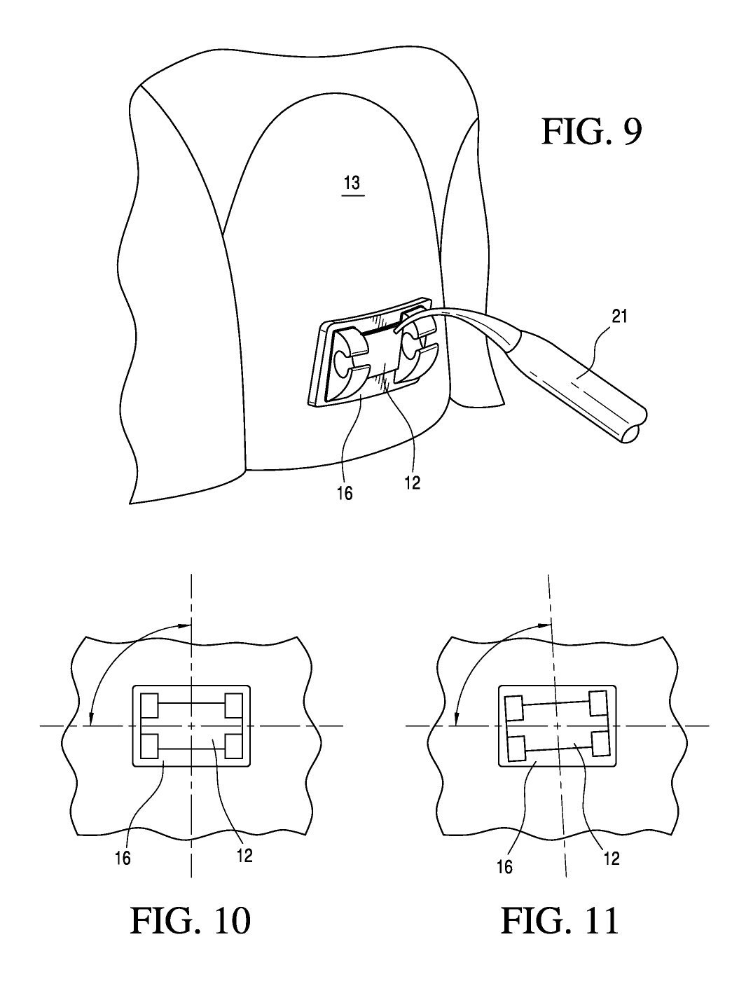

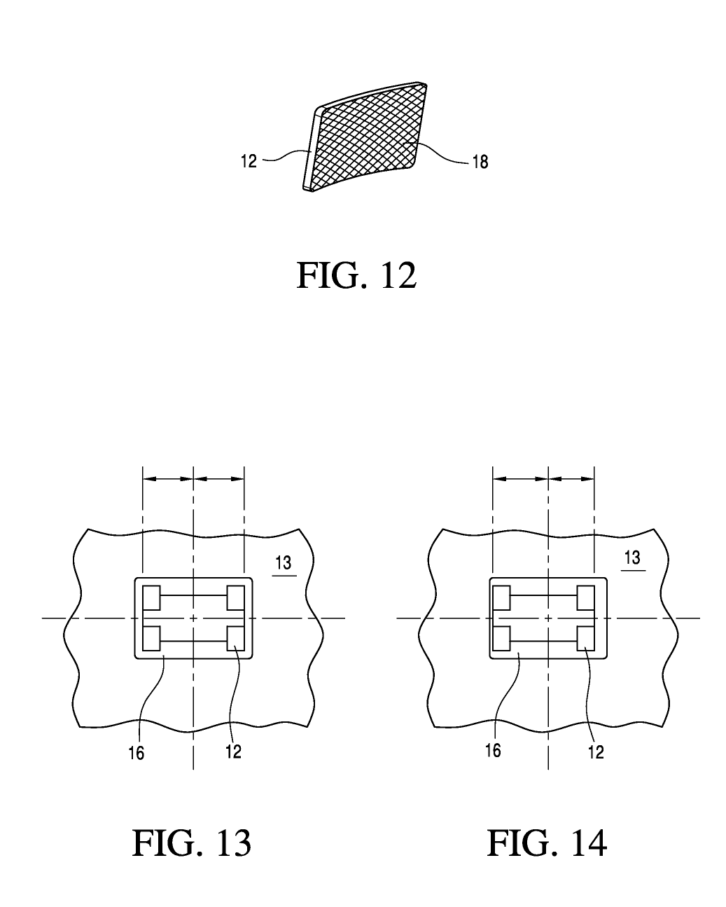

As illustrated in FIG. 9 the tip of a laser 21 is used to adjust the positions of an orthodontic bracket 12 on a tooth 13 when the heat softenable layer 18 is in a liquidous stage. For example, FIG. 10 shows an original position of a bracket 12 while FIG. 11 illustrates a slight rotation adjustment of the bracket 12. The best way to move a bracket is to move the bracket with the tip of the laser which may be a bit thicker than usual to facilitate this approach.

For contrast, FIG. 13 illustrates the position of an orthodontic bracket 12 fixed to a base member 16 on a tooth 13 in an initial position while FIG. 14 illustrates a similar bracket 12 fixed by a base member 16 to a tooth 13 but with a linear adjustment by a small movement to the left or the right.

While the invention has been described in connection with its preferred embodiments it should be recognized that changes and modifications may be made therein without departing from the scope of the appended claims.

What is claimed is:

1. An adjustable orthodontic bracket comprising:
a thin layer of an orthodontic adhesive, and a metal base member adapted to be rigidly secured directly to a tooth by said layer of adhesive;
a layer of lead-free heat softenable material for joining two metal surfaces rigidly together; and
an orthodontic bracket having a base to fit within a surface area of said base member and an engagement receiver for receiving an archwire by which orthodontic forces developed on the patient's teeth so they can be moved.

2. The adjustable orthodontic bracket according to claim 1, in which said heat softenable material goes through a liquidous stage so that the position of said bracket can be adjusted with respect to the tooth and wherein said base member overlaps said base of said bracket by between 0.5 mm and up to about 1.0 mm surrounding said base so that said bracket can be adjusted by an amount of up to about 1.0 mm in all directions around said base member without overlapping the periphery of said base member.

3. The adjustable orthodontic bracket according to claim 2, in which said heat softenable material is a lead-free solder.

4. The adjustable orthodontic bracket according to claim 3, in which said orthodontic solder is a silver solder having copper between 19-60% of mixture, nickel 0.5-5%, silver between 1.5-55% and zinc between 4-44% and a melting point of about 138° C. or less.

5. An adjustable orthodontic bracket consisting of:
a thin layer of an orthodontic adhesive, and a metal base member adapted to be rigidly secured directly to a tooth by said layer of adhesive;
a layer of lead-free heat softenable material for joining two metal surfaces rigidly together;
an orthodontic bracket having a base to fit within a surface area of said base member and an engagement receiver for receiving an archwire by which orthodontic forces are developed on a patient's teeth; and
wherein said base member overlaps said base of said bracket by between 0.5 mm and up to about 1.0 mm surrounding said base so that said bracket can be adjusted by an amount of up to about 1.0 mm in all directions around said base member without overlapping the periphery of said base member.

6. An adjustable orthodontic bracket comprising:
a thin layer of an orthodontic adhesive, and a metal base member adapted to be rigidly secured directly to a tooth by said layer of adhesive;
a layer of lead-free heat softenable material for joining two metal surfaces rigidly together;
an orthodontic bracket having a base to fit within a surface area of said base member and an engagement receiver for receiving an archwire by which orthodontic forces developed on the patient's teeth so they can be moved; and
wherein an adjustment may be made by sliding or translation of said orthodontic bracket on said base member.

7. A method for adjusting an orthodontic bracket without breaking a bond between a patient's tooth and an orthodontic bracket, said method comprising the step of:
providing a thin layer of an orthodontic adhesive, and a metal base member adapted to be rigidly secured directly to a tooth by said layer of adhesive;
a layer of heat softenable material wherein the surface of the heat softenable material reaches a liquidous stage under heat for bonding two metal surfaces rigidly together and an orthodontic bracket having a base and wherein said base member overlaps said base of said bracket by between 0.5 mm and up to about 1.0 mm on each side thereof so that said bracket can be adjusted by an amount of up to about 1.0 mm in all planar directions without overlapping said base member;
providing a diode laser to generate a pinpoint output of about 138° C.;
rigidly fastening said base member directly to a patient's tooth and bonding said surfaces of said base member and said base together with said heat softenable material and heating said heat softenable material to form a liquidous phase between said base member and said base of said bracket;
adjusting the position of said bracket with respect to adjacent teeth and brackets to a tooth in a preselected manner; and
removing the heat from said heat softenable material to harden the heat softenable material.

8. A method for adjusting an orthodontic bracket without breaking a bond between a patient's tooth and an orthodontic bracket, said method consisting of:
providing a thin layer of an orthodontic adhesive, and a metal base member adapted to be rigidly secured directly to a tooth by said layer of adhesive;
a layer of heat softenable material wherein the surface of the heat softenable material reaches a liquidous stage under heat for bonding two metal surfaces rigidly together and an orthodontic bracket having a base and wherein said base member overlaps said base of said bracket by between 0.5 mm and up to about 1.0 mm on each side thereof so that said bracket can be adjusted by an amount of up to about 1.0 mm in all planar directions without overlapping said base member;
providing a diode laser to generate a pinpoint output of about 138° C.;
rigidly fastening said base member directly to a patient's tooth and bonding said surfaces of said base member and said base together with said heat softenable material and heating said heat softenable material to form a liquidous phase between said base member and said base of said bracket;
adjusting the portion of said bracket with respect to adjacent teeth and brackets to a tooth in a preselected manner; and
removing the heat from said heat softenable material to hardened to heat softenable material.
